(19) United States
(12) Patent Application Publication
(10) Pub. No.: US 2006/0199486 A1
(43) Pub. Date: Sep. 7, 2006

(54) Condensation scalding tunnel for slaughter animals

(76) Inventor: Hermann Briel, Hatzfeld/Eifa (DE)

Correspondence Address: DENNISON, SCHULTZ & MACDONALD, 1727 KING STREET, SUITE 105, ALEXANDRIA, VA, 22314, US

(21) Appl. No.: 10/554,391

(22) PCT Filed: Apr. 26, 2004
(86) PCT No.: PCT/EP04/04395

§ 371 Date: Oct. 24, 2005

(30) Foreign Application Priority Data
Apr. 24, 2003 (DE) 103 18 657.3

(51) Int. Cl. A22B 5/08

(52) U.S. Cl. 452/74

(57) ABSTRACT

A scalding tunnel for slaughter animals such as pigs or goats, including steam-discharging nozzles which are mounted inside the scalding tunnel and along the path of conveyance of the slaughter animals. The scalding tunnel has a structurally simple design and operates in an energy efficient manner. To be able to set homogeneous or largely homogeneous environmental conditions inside the scalding tunnel, the invention provides that the nozzles are multicomponent-discharging nozzles having at least one connection for steam and one connection for water, whereby the nozzles discharge a mixture including steam and water that is sprayed therein.

The invention relates to a scalding tunnel for slaughter animals such as pigs or goats, comprising steam-discharging nozzles which are mounted inside the scalding tunnel and along the path of conveyance of the slaughter animals. Furthermore, the invention relates to a method for scalding slaughter animals such as pigs or goats in a scalding tunnel, a mixture of steam and water being sprayed inside the scalding tunnel.

Some types of slaughter animals, in particular typically pigs, are usually scalded in an early phase of the slaughtering process after having been killed. The skin of the slaughter animal is softened with a lot of moisture or water by the scalding and usually reaches a temperature in the range of 55° C. to 65° C. The bristles or hairs of the slaughter animal can be removed comparatively easily from the scalded skin. Moreover, the scalding removes dirt which has adhered to the outside of the slaughter animal.

The most traditional type of scalding was to immerse each slaughter animal in a long basin with warm scalding water and to move it along the basin. More recently, the tendency has been to use condensation scalding tunnels in which the suspended slaughter animals are subjected to very moist air. The skin of the slaughter animal is softened in the desired manner and brought to the desired temperature by means of a suitably high temperature of the air and by partial condensation of the moisture on the slaughter animal. Scalding tunnels are designed for the passage of slaughter animals, i.e. a number of slaughter animals are conveyed through the scalding tunnel one after the other in its longitudinal direction per unit of time. The speed of conveyance of the slaughter animals through the scalding tunnel and the length of the scalding tunnel are determined in such a way that the required stay of the respective slaughter animal in the atmosphere of the scalding tunnel is established.

Previous condensation scalding tunnels have one or more ventilators which intensively circulate the atmosphere inside the scalding tunnel, each through an outer circulating channel in addition to the actual scalding tunnel, so that largely homogeneous conditions prevail for the slaughter animals to be scalded and an intensive heat exchange and mass transfer takes place between the atmosphere in the scalding tunnel and the body surface of the slaughter animals. In longer condensation scalding tunnels, there are several circulating channels of this type distributed over the length of the scalding tunnel, each with a ventilator.

This construction of condensation scalding tunnels is expensive in its production, requires a lot of space in the slaughterhouse and is expensive in the continuous power consumption and in the constant maintenance.

According to the prior art, it is also known to discharge water through spray nozzles and steam through steam lances in a side channel of the scalding tunnel which, in turn, is connected with the scalding tunnel. Furthermore, there is a ventilator in the side channel to convey the mixture of water and steam from the side channel into the scalding tunnel. Due to the design, the mixture of steam and sprayed water must thereby be repeatedly reversed, which results in a condensation and thus a “drying” of the steam. This often leads to the fact that the required humidity does not prevail in the scalding tunnel.

In a scalding tunnel according to U.S. Pat. No. 3,631,563, steam and hot water are sprayed along the path of conveyance of slaughtered poultry. In this case, hot water is introduced into a line leading to a nozzle through which the steam is sprayed.

In U.S. Pat. No. 1,146,589, perforated pipes are arranged in a scalding tunnel for slaughter animals along their path of conveyance in order to optionally spray steam with a condensate mixture.

In the scalding tunnel of the aforementioned type according to WO 98/32334, high-pressure steam nozzles are arranged in the base area in order to directly spray slaughter animals.

The object of the present invention is to further develop a scalding tunnel of the aforementioned type, as well as a method for scalding slaughter animals, in such a way that, with a structurally simple design of the scalding tunnel, it can be operated in an energy efficient manner. It should thereby be possible to set homogeneous or largely homogeneous environmental conditions inside the scalding tunnel itself without the need for expensive circulating devices.

To solve the problem, a scalding tunnel of the aforementioned type essentially provides that the nozzles are multicomponent nozzles with at least one connection for steam and one connection for water, whereby the nozzles discharge a mixture of steam and of water that is sprayed therein.

In contrast to the previously known prior alt, multicomponent nozzles are used to which water and steam are directly supplied in order to then spray an especially supersaturated mixture of water and steam through the multicomponent nozzles. The nozzles are thereby arranged in such a way that atmosphere present within the scalding tunnel is circulated, so that homogeneous humidity conditions result. At the same time, this enables the scalding tunnel to be operated without ventilators. As a result, the invention is also characterized by the feature that the scalding tunnel can be operated without ventilators.

In other words, several multicomponent nozzles are arranged in the scalding tunnel along its length, said multicomponent nozzles in operation each discharging a mixture of steam and of water that is sprayed therein at such a high speed that the atmosphere in the scalding tunnel is circulated.

With the invention, it was surprisingly found that such an intensive circulating effect can be exerted on the inner atmosphere of the scalding tunnel with steam/water multicomponent nozzles that, preferably, circulating ventilators can be completely omitted, or at least, however, the number and/or the output of circulating ventilators can be quite substantially reduced. By means of the steam/water multicomponent nozzles, sufficiently good homogeneity of the atmosphere in the scalding tunnel and sufficiently intensive heat exchange and mass transfer (condensation of water) on the body surfaces of the slaughter animals located in the scalding tunnel can be obtained at low cost. The scalding tunnel is economical to make, requires little space in the slaughterhouse, is less demanding with respect to maintenance and consumes less energy for its operation.

Preferably, at least the majority, and particularly preferably all, of the multicomponent nozzles are arranged in the base area of the scalding tunnel. With just this arrangement, the circulating effect produced by the multicomponent nozzles is sufficient. The arrangement predominantly or exclusively in the base area simplifies the feed lines for steam and water to the multicomponent nozzles.

Preferably, the majority, and particularly preferably all, of the multicomponent nozzles are directed in such a way that their discharge jets are directed with substantial, and preferably predominant, components in longitudinal direction of the scalding tunnel. In this way, the spacings between multicomponent nozzles, spaced apart longitudinally of the scalding tunnel, are well provided with a scalding medium (mixture of steam and water that is sprayed therein) and with circulation. Alternatively or in addition, it is preferred that the discharge jet at least the majority, and particularly preferably all, of the multicomponent nozzles is directed upwardly inclined. It is preferred that a part of the multicomponent nozzles is directed with components in the direction of conveyance of the slaughter animals in the scalding tunnel and another part of the multicomponent nozzles with components opposite to the direction of conveyance of the slaughter animals in the scalding tunnel. This reduces the number of positions in which feed lines for steam and water must be run and improves the circulation effect.

Preferably, in a plan view, at least the majority, and particularly preferably all, of the multicomponent nozzles are arranged on only one longitudinal side of the scalding tunnel. Preferably, the multicomponent nozzles are directed with components in the direction of the vertical longitudinal median plane of the scalding tunnel. It was surprisingly shown that the correct functioning of the scalding tunnel can be obtained even with multicomponent nozzles arranged on only one longitudinal side of the scalding tunnel. The cost of the lines to the nozzles is minimized. Alternatively, it is possible to arrange multicomponent nozzles on both longitudinal sides of the scalding tunnel.

Independently thereof, the multicomponent nozzles should be arranged in the scalding tunnel in such a way that a direct impact of the slaughter animals by the mixture discharged directly from the multicomponent nozzles does not take place. As a result, scaldings are excluded.

A method for scalding slaughter animals of the aforementioned type distinguishes itself especially in that the mixture consisting of steam and water is sprayed through multicomponent nozzles arranged directly inside the scalding tunnel and to which both water and steam are supplied directly. In this case, a supersaturated mixture of water and steam is sprayed, in particular through the multicomponent nozzles.

Furthermore, it is provided that the temperature of the mixture sprayed through the multicomponent nozzles is set such that the mixture has a temperature T₁, where T₁>100° C., in particular T₁>120° C., preferably 120° C.≦T₁≦160° C., on discharge from the multicomponent nozzles.

According to a development of the invention, it is provided that the temperature of the mixture sprayed through the multicomponent nozzles is set, and/or the multicomponent nozzles are arranged in the scalding tunnel, such that the mixture striking the slaughter animals has a temperature T₂ where, in particular, 55° C.≦T₂°≦70° C.

Preferably, at least the majority, and particularly preferably all, of the multicomponent nozzles are supplied with steam at 0.5 bar absolute pressure to 10 bar superatmospheric pressure, particularly preferably 2 bar to 6 bar superatmospheric pressure. Pressures above atmospheric pressure of this type can be handled without difficulty. The required amount of steam can also be introduced into the scalding tunnel with small outlet cross-sections for the steam in the multicomponent nozzles and with a desired small number of multicomponent nozzles for the entire scalding tunnel.

Preferably, the majority, and particularly preferably all, of the multicomponent nozzles are supplied with steam at 80° C. to 200° C., preferably 120° C. to 160° C. Temperatures of this type can be technically handled without difficulty and lead to the required power supply inside the scalding tunnel with an amount of steam that can be easily handled.

Preferably, the majority, and particularly preferably all, of the multicomponent nozzles are supplied with saturated or (slightly) supersaturated steam. Once the steam has been discharged from the multicomponent nozzles and released to about ambient pressure, and due to the introduction of finely sprayed water into the steam, a strong supersaturation of the atmosphere in the scalding tunnel results. Consequently, water is condensed, preferably there in the scalding tunnel where an object is located which has lower temperatures than other objects located there; such relatively cold “objects” will primarily be the slaughter animals newly conveyed into the scalding tunnel and any colder zones of the body surfaces of the slaughter animals.

Preferably, at least the majority, and particularly preferably all, of multicomponent nozzles are supplied with water at 0.1 bar to 4 bar, particularly preferably with water at 0.2 to 2 bar. Preferably, at least the majority, and particularly preferably all, of the multicomponent nozzles are supplied with water at 10° C. to 90° C., particularly preferably with water at 20° C. to 70° C. The warmer the water, the better it can be sprayed; the difference in temperature relative to the steam is not as great. Generally, the scalding tunnel is designed in such a way that the steam is supplied to the multicomponent nozzles at higher pressure than the water.

The amount of steam and water which is discharged into the scalding tunnels through the multicomponent nozzles depends essentially on the following parameters: superatmospheric pressure when supplied to the nozzles, flow cross-sections in the nozzles, number of nozzles. When saturated steam is supplied to the nozzles, its pressure and its temperature are interrelated according to the known phase diagram.

Preferably, a volume control is provided for the amount of steam supplied to the multicomponent nozzles. Preferably, a volume control is provided for the amount of water supplied to the multicomponent nozzles. In most cases, “volume control” means that the amount per time unit is kept constant by the control. Of course, this does not exclude that this amount can be adjusted, which is even preferred. The said volume controls can be common for all multicomponent nozzles, but alternatively each can only be common for a subgroup of the multicomponent nozzles.

Preferably, the scalding tunnel has a temperature control. It is especially preferred to control the temperature by changing the amount of steam introduced altogether into the scalding tunnel per time unit. For this purpose, all multicomponent nozzles, or alternatively only some of the multicomponent nozzles, can be actuated by means of the temperature control device. Control valves can be used in the steam supply to the multicomponent nozzles, indeed either with a single control valve for all multicomponent nozzles to be controlled or with a control valve for some of the multicomponent nozzles to be controlled, or with a control valve for each multicomponent nozzle to be controlled.

A scalding tunnel according to the invention can also be produced by converting an existing water scalding tunnel (hot scalding water is sprayed in a shower-like manner over the slaughter animals) to the multicomponent nozzles.

Further details, advantages and features of the invention can be found not only in the claims, the features found in them—alone and/or in combination—but also in the following description of the preferred embodiments found in the drawings.

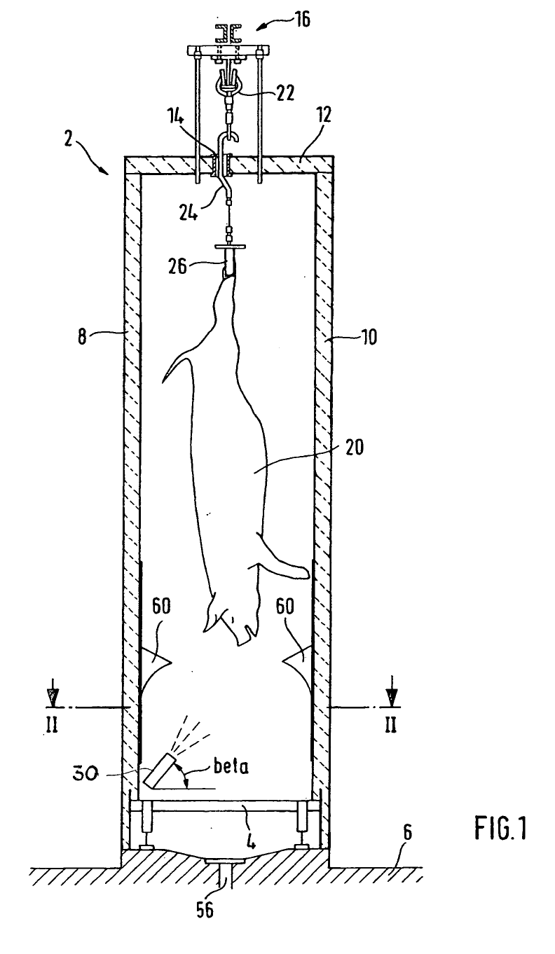

FIG. 1 shows a condensation scalding tunnel in a vertical cross-section,

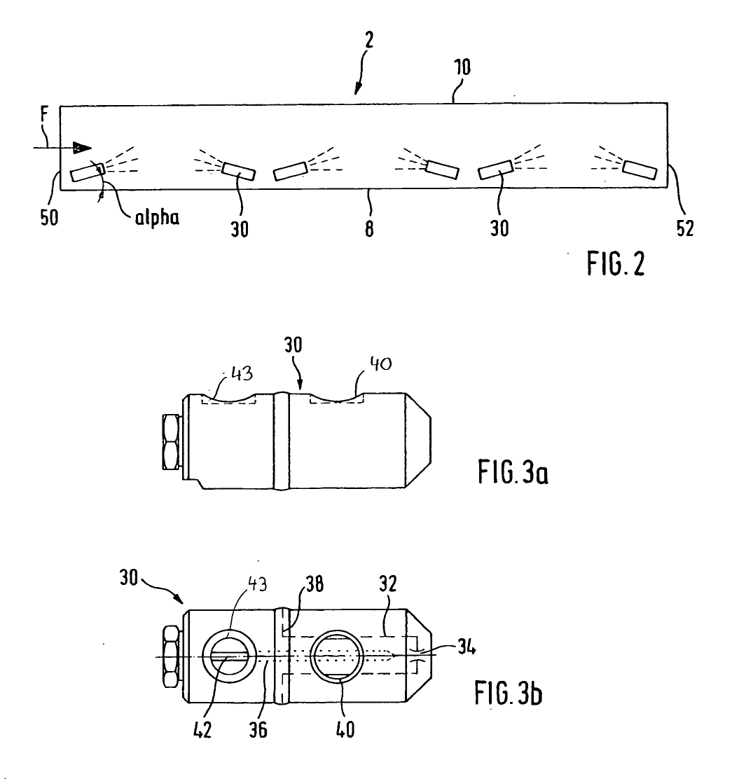

FIG. 2 shows the scalding tunnel of FIG. 1 in the horizontal longitudinal section along II-II, on a smaller scale than in FIG. 1,

FIG. 3a shows a multicomponent nozzle in a side view, and

FIG. 3b shows the multicomponent nozzle of FIG. 3a in a side view, but after turning the multicomponent nozzle by 90° about its longitudinal axis.

The invention will be described in greater detail in the following with reference to a scalding tunnel illustrated purely in principle. The term dual component nozzle will be used in this connection. This is a subcase of a multicomponent nozzle to which more than two media flows can be simultaneously supplied. Independently thereof, both dual component and multicomponent nozzles functionally achieve the combination of a steam flow and a flow consisting of sprayed water.

A scalding tunnel 2 for pigs shown in FIG. 1 consists essentially of a substructure 4 which is placed on a slaughterhouse floor 6, two lateral walls 8 and 10, a ceiling 12 with a longitudinal slot 14 and an associated section of a conveyor track 16. The direction of conveyance of the slaughter animals 20 runs at a right angle to the plane of the drawing of FIG. 1.

The lateral walls 8, 10 and the ceiling 12 are each made double-walled, consisting of two high-grade steel plates with thermal insulation extending therebetween. The conveyor track section 16 is a section of a conventional conveyor track comprising a conveyor chain, not shown separately in the drawing, which through drive members moves individual trolleys 22, from each of which hangs a hook 24 on which a slaughter animal 20 is suspended through a sling chain 26. The sling chain 26 thereby engages a hind leg of the slaughter animal 20. The hook 24 passes through the slot 14, so that the conveyor track section 16 is located above and outside of the actual scalding tunnel 2 and the slaughter animals can nevertheless be conveyed longitudinally of the scalding tunnel 2. In front of the plane of the drawing of FIG. 1 and behind the plane of the drawing of FIG. 1, one has to imagine slaughter animals 20, so that a whole row of slaughter animals 20 are simultaneously conveyed through the scalding tunnel 2.

The direction of conveyance F is indicated by an arrow in FIG. 2. The longitudinal direction of the scalding tunnel is from the left to the right in FIG. 2. The length of the scalding tunnel 2 is e.g. 10 m, the width e.g. about 1 m. However, these numbers do not restrict the teaching of the invention.

It can be seen in FIG. 2 that the scalding tunnel 2 is furnished with altogether six multicomponent nozzles 30, briefly called “nozzle 30” in the following. Quite close to the start 50 of the scalding tunnel, the first nozzle 30 is positioned, directed toward the inside of the scalding tunnel. It is e.g. directed at an angle alpha, measured in the horizontal plane relative to the longitudinal direction of the scalding tunnel 2, of 5° to 15°, and at an angle beta, measured in a vertical plane and relative to the horizontal, of 30° to 50°.

At a spacing of approximately 3 m from the first nozzle 30, there are located a pair of nozzles 30, and more particularly one nozzle 30 oriented opposite the direction of conveyance F and the other nozzle 30 in direction of conveyance F. The angular orientations of these two nozzles are respectively similar to and mirror-images of the described angular orientations of the first nozzle 30. Again, at a distance of about 3 m, a further pair of nozzles 30 follows, similar to the previously described pair of nozzles 30. Just before the outlet end 52 of the scalding tunnel 2, a last nozzle 30 is positioned, directed oppositely to the direction of conveyance F into the interior of the scalding tunnel 2; the angular orientations are mirror-images of the first nozzle 30.

Independently thereof, the angles alpha and beta should be selected such that the discharge jet of the multicomponent nozzles do not directly strike the slaughter animals 20.

Each of the nozzles 30 is connected to a first line for steam and a second line for water, these lines not being shown in FIG. 1 and FIG. 2 to improve visibility.

FIG. 2 illustrates that all nozzles 30 are positioned on a single longitudinal side 54 of the scalding tunnel 2. As a result, the positioning of the lines in question and their installation during production of the scalding tunnel 2 are extremely simple. It can also be seen in FIG. 1 that the nozzles 30 are arranged in the base area of the scalding tunnel 2, i.e. not far from the lower end of the respective lateral wall 10. It can be seen in FIG. 1 that the lower end of the scalding tunnel 2 is configured as a groove-like depression with one or more discharge pipes 56, so that water which is condensed on the slaughter animals 20 or also on the inside of the walls 8, 10 can flow off downwardly.

The nozzle 30, shown in greater detail in FIGS. 3a and 3b has an inner cylindrical flow channel 32. indicated by broken lines, in its right-hand part. On the right-hand end in FIGS. 3a and 3b, the flow channel 32 is sealed by a wall which centrally comprises a diagrammatically illustrated opening 34 of a small diameter. On the left end in FIGS. 3a and 3b, the flow channel 32 is open, with the exception of a needle 36 still to be described. On the left end, the flow channel part is held in the nozzle 30 by means of a disk 38. A radial bore 40 provides the connection between a line (not shown), screwed thereon, through which steam is supplied, and an annular space between the flow channel component and the cylindrical periphery of the overall nozzle component 30.

The needle 36, shown in dotted lines in FIG. 3b, extends along the central axis 42 of the nozzle, namely from the left end in FIGS. 3a and 3b to a bit before the discharge opening 34 of the flow channel 32. On the left end, the needle 36 is enlarged in diameter and provided with a thread, so that it can be screwed into the overall nozzle component 30 from the left. In the right end area, the needle 36 is provided, for the majority of its partial length located within the flow channel 32, with an outer helix of a large pitch (not shown). A radial bore 43 provides a connection between a line (not shown) screwed onto it, through which the water is supplied, and the inside of the left section of the nozzle 30. This interior space is open toward the inside of the flow channel 32.

FIGS. 3a and 3b show the nozzle in a size which is slightly reduced relative to the natural size.

The above-described nozzle 30 produces an intensive mixture of steam with water that is very finely sprayed therein, more or less a water aerosol in the steam. The steam flows at a high speed through the annular space between the flow channel 32 and the peripheral wall of the nozzle 30. The high flow velocity entails a reduction of the static pressure at the opening 34 (venturi effect). The above-described helical shape on the needle 36 causes a torsional flow of the water in the flow channel 32. The opening or bore 34 typically has a diameter of 1 mm to 5 mm. The water droplets sprayed in the steam have a size in the μm range.

Preferably, the steam supplied to the dual component nozzle 30 has residual humidity of 20% to 30%, in particular in the range of 25%. The pressure with which the steam is supplied to the dual component nozzle 30 is preferably in the range of between 2 bar to 10 bar above atmospheric pressure, in particular 4 bar.

Due to the water supplied to the dual component nozzle and its spraying through the dual component nozzle 30, the mixture consisting of steam and sprayed water which leaves the nozzle 30 has residual humidity in the range of between 50% and 70%, in particular, about 60%. In this case, the amount of residual humidity depends on the temperature and amount of water supplied to the dual component nozzle. In particular, the water temperature should be between 40° C. and 90° C.

Furthermore, it should be noted that, due to the spraying of the steam through the dual component nozzle 30, a reduction of atmospheric pressure occurs.

It is stressed that it is alternatively possible to arrange nozzles 30 on both longitudinal sides of the scalding tunnel 2. Furthermore, it is stressed that, instead of in the base area, it is alternatively possible to place nozzles further up inside the scalding tunnel 2 or to provide two additional nozzles 30 further up inside the scalding tunnel. Altogether, it is possible to specifically position and align nozzles 30 at those points where difficult-to-soften body parts of the slaughter animals are located.

The longitudinally extending attachments 60, which can be seen inside on the lateral walls 8, 10 in FIG. 1, improve the vorticity of the scalding medium (steam with water that is sprayed therein) inside the scalding tunnel 2 and convey water condensed thereon, which flows down the lateral walls 8, 10, more toward the centre of the scalding tunnel 2.

1. A scalding tunnel (2) for slaughter animals (20), such as pigs or goats, with steam-discharging nozzles (30) mounted in the scalding tunnel and along the path of conveyance (F) of the slaughter animals, characterized in that the nozzles (30) are multicomponent nozzles with at least one connection (40) for steam and one connection (43) for water, whereby the nozzles discharge a mixture of steam and water that is sprayed therein.

2. The scalding tunnel according to claim 1, characterized in that the multicomponent nozzles (30) are arranged in the scalding tunnel (2) in such a way that atmosphere present in the scalding tunnel can be circulated.

3. The scalding tunnel according to claim 1, characterized in that the multicomponent nozzles (30) are arranged, at least for the most part, in the base area of the scalding tunnel (2).

4. The scalding tunnel according to claim 1, characterized in that the multicomponent nozzles (30) are oriented, at least for the most part, in such a way that their discharge jet is directed with a substantial component longitudinally of the scalding tunnel (2).

5. The scalding tunnel according to claim 1, characterized in that one part of the multicomponent nozzles (30) is directed with components in the direction of conveyance (F) of the slaughter animals (20) in the scalding tunnel (2) and another part of the multicomponent nozzles (30) is directed with components opposite to the direction of conveyance (F) of the slaughter animals (20) in the scalding tunnel (2).

6. The scalding tunnel according to claim 1, characterized in that in plan view, the multicomponent nozzles (30) are arranged, at least for the most part, on one longitudinal side of the scalding tunnel (2).

7. The scalding tunnel according to claim 1, characterized in that a volume control is provided for the amount of steam supplied to the multicomponent nozzles (30).

8. The scalding tunnel according to claim 1, characterized in that a volume control is provided for the amount of water supplied to the multicomponent nozzles (30).

9. The scalding tunnel according to claim 1, characterized in that for temperature control at least one control valve is provided for the amount of steam supplied to at least one multicomponent nozzles (30).

10. The scalding tunnel according to claim 1, characterized in that only a part of the multicomponent nozzles (30) is included in the temperature control.

11. The scalding tunnel according to claim 1, characterized in that all the multicomponent nozzles (30) are included in the temperature control.

12. The scalding tunnel according to claim 1, characterized in that the scalding tunnel (2) is designed without ventilators for circulating its internal atmosphere.

13. The scalding tunnel according to claim 1, characterized in that the multicomponent nozzle (30) is a dual component nozzle.

14. The scalding tunnel according to claim 1, characterized in that the multicomponent nozzle (30) is oriented to the horizontal in such a way that its direction of longitudinal discharge, relative to the horizontal, describes an angle β, where in particular 5°≦α≦15°.

15. The scalding tunnel according to claim 1, characterized in that the multicomponent nozzle (30) describes an angle β relative to the vertical with its direction of longitudinal discharge, where preferably 30°≦β≦50°.

16. A method for scalding slaughter animals such as pigs or goats in a scalding tunnel (2), whereby a mixture of steam and water is sprayed in the scalding tunnel, characterized in that the mixture of steam and water is sprayed through multicomponent nozzles (30) arranged directly in the scalding tunnel (2) and to which both water and steam are directly supplied.

17. The method according to claim 16, characterized in that a supersaturated mixture of water and steam is sprayed through the multicomponent nozzles (30).

18. The method according to claim 16, characterized in that the temperature of the mixture sprayed through the multicomponent nozzles (30) is set such that, on discharge from the multicomponent nozzles, the mixture has a temperature T₁, where T₁≧100° C., in particular T₁≧120° C., preferably 120° C.≦T₁≦16020 C.

19. The method according to claim 16, characterized in that the temperature of the mixture sprayed through the multicomponent nozzles (30) is set, and/or the multicomponent nozzles are arranged in the scalding tunnel (2), such that the mixture striking the slaughter animal (20) has a temperature T₂ where in particular 55° C.≦T₂≦70° C.

20. The method according to claim 16, characterized in that the multicomponent nozzles (30) are arranged in the scalding tunnel (2) in such a way that a circulation of the atmosphere present in the scalding tunnel is effected to such a degree that homogeneous or substantially homogeneous humidity conditions prevail in the scalding tunnel.

21. The method according to claim 16, characterized in that the scalding tunnel (2) is operated without ventilators.

22. The method according to claim 16, characterized in that the multicomponent nozzles (30) are supplied, at least for the most part, with steam at 2 bar to 6 bar superatmospheric pressure.

23. The method according to claim 16, characterized in that the multicomponent nozzles (30) are supplied, at least for the most part, with steam at 120° C. to 160° C.

24. The method according to claim 16, characterized in that the multicomponent nozzles (30) are supplied, at least for the most part, with saturated or supersaturated steam.

25. The method according to claim 16, characterized in that the multicomponent nozzles (30) are supplied, at least for the most part, with water at about 0.2 bar superatmospheric pressure.

26. The method according to claim 16, characterized in that the dual component nozzles (30) are supplied, at least for the most part, with water having a temperature of 20° C. to 70° C.
